(19) United States
(12) Patent Application Publication
(10) Pub. No.: US 2017/0054540 A1
(43) Pub. Date: Feb. 23, 2017

(54) METHOD AND APPARATUS FOR OPPORTUNISTIC DATA TRANSMISSION

(71) Applicant: Electronics and Telecommunications Research Institute, Daejeon (KR)

(72) Inventor: Ji Hyung KIM, Daejeon (KR)

(21) Appl. No.: 15/237,774

(22) Filed: Aug. 16, 2016

(30) Foreign Application Priority Data
Aug. 19, 2015 (KR) 10-2015-0116954

(51) Int. Cl. H04L 5/00; H04W 4/00

(52) U.S. Cl. CPC H04L 5/0048; H04W 4/005; H04W 88/02

(57) ABSTRACT

When a device-to-device (D2D) terminal simultaneously receives control information from two or more different D2D terminals, the D2D terminal transmits control information of a first D2D terminal of at least one of the two or more D2D terminals to a second D2D terminal of at least the other one of the two or more D2D terminals.

### CROSS-REFERENCE TO RELATED APPLICATION

This application claims priority to and the benefit of Korean Patent Application No. 10-2015-016954 filed in the Korean Intellectual Property Office on Aug. 19, 2015, the entire contents of which are incorporated herein by reference.

### BACKGROUND OF THE INVENTION

(a) Field of the Invention

The present invention relates to a method and an apparatus for opportunistic data transmission, and more particularly, to a method and an apparatus for opportunistic data transmission for enhancing efficiency of resources in a wireless communication system.

(b) Description of the Related Art

In respect to communication between terminals, device-to-device (D2D) is standardized in long term evolution (LTE).

In the LTE-D2D, a transmitting terminal basically transmits a sidelink control information (SCI) format 0 through a physical sidelink control channel (PSCCH) which is a control channel, and a receiving terminal detects and restores a physical sidelink shared channel (PSSCH) which is a following data channel by using information on the SCI format 0. That is, in the LTE-D2D, a PSCCH transmission period is present and next, a PSSCH transmission period is present.

In the SCI format 0, a reception group identifier, resource position information of the PSSCH, and the like are included. Accordingly, when the PSCCH is not restored, the resource position of the PSSCH is not determined, and the receiving terminal which does not determine the resource position of the PSSCH should search the entire PSSCH transmission period by a blind scheme and estimate various information to restore the PSSCH.

Meanwhile, in the PSCCH transmission period, different terminals may simultaneously transmit control information and communicate with a base station. In the D2D, since the terminal uses a half-duplex transmission scheme in which only transmission or reception is possible at one timing, in the case of transmission in the PSCCH transmission period, the terminal may not receive the control information of another terminal, and thus, there is a problem in that the data in the PSSCH transmission period for the control information of the other terminal may not be restored.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and an apparatus for opportunistic data transmission having advantages of recovering data from a counter terminal when terminals using a half-duplex transmission scheme simultaneously transmit control information while communicating between the terminals.

An exemplary embodiment of the present invention provides a method for opportunistic data transmission in a device-to-device (D2D) terminal. The method for opportunistic data transmission includes receiving control information simultaneously from two or more different D2D terminals; and transmitting control information of a first D2D terminal of at least one of the two or more D2D terminals to a second D2D terminal of at least the other one of the two or more D2D terminals.

The transmitting may include determining whether the second terminal needs to receive the control information of the first terminal.

The control information may include information on a resource position of the D2D data to be transmitted by the corresponding D2D terminal and priority of the D2D data.

The control information may further include event-driven information of the D2D data.

The control information may be mapped in a transmission resource of a physical sidelink control channel (PSCCH) and a demodulation reference signal capable of distinguishing the PSCCH may be mapped in another transmission resource of the PSCCH.

The determining may include determining whether the second terminal needs to receive the control information of the first terminal based on the information on the priority of the D2D data to be transmitted by the first terminal.

The transmitting may include determining a resource position of the D2D data to be transmitted by the second terminal base on the control information of the second terminal, and transmitting the control information of the first D2D terminal for a partial period except for the resource position of the D2D data to be transmitted by the second terminal in the set data period.

The resource position may include a time position.

The partial period may include a period temporally just before or just after the resource position of the D2D data to be transmitted by the second terminal.

The method for opportunistic data transmission may further include receiving the D2D data from the two or more different D2D terminals.

The receiving of the control information may include transmitting the control information repetitively two times by the two or more different D2D terminals in the control period, and the receiving of the D2D data may include transmitting the D2D data repetitively four times by the two or more different D2D terminals in the data period.

Another exemplary embodiment of the present invention provides an apparatus for opportunistic data transmission in a device-to-device (D2D) terminal. The apparatus for opportunistic data transmission includes a transceiver and a processor. The transceiver receives control information simultaneously from two or more different D2D terminals in a control period. In addition, the processor determines whether to transmit control information of a first D2D terminal of at least one of the two or more D2D terminals to a second D2D terminal of at least the other one of the two or more D2D terminals, sets the second D2D terminal as a reception identifier, and maps the control information of the first D2D terminal in a transmission resource in the data period.

The control information may include at least one of information on priority of the D2D data to be transmitted by the corresponding D2D terminal and event-driven information of the D2D data and a transmission resource position of the D2D terminal.

The processor may determine whether to transmit the control information of the first D2D terminal to the second D2D terminal based on at least one of the information on the priority of the D2D data and the event-driven information of the D2D data.

The processor may determine a resource position of the D2D data to be transmitted by the second terminal based on the control information of the second terminal, and map the control information of the first D2D terminal in a transmission resource of a partial period except for the transmission resource position of the D2D data to be transmitted by the second terminal in the data period.

The partial period may include a period temporally just before or just after at the resource position of the D2D data to be transmitted by the second terminal.

The control information may be included in a sidelink control information (SCI) format 0, and the processor may detect a physical sidelink control channel (PSCCH) in the control period to determine control information in the SCI format 0.

The processor may include the information on the priority of the D2D data to be transmitted and the information on the event-driven of the D2D data in SCI format 0 when the D2D data to be transmitted is generated, repetitively allocate the PSCCH two times in the control period, and map the SCI format 0 in the transmission resource position of the PSCCH repetitively allocated two times.

The processor may repetitively allocate a physical sidelink shared channel (PSSCH) four time in the data period and map the D2D data to be transmitted in the transmission resource position of the PSSCH repetitively allocated four times.

The processor may set a predetermined time period temporally just before or just after based on the transmission resource position of the allocated PSSCH in the data period as a reception period and detect the PSCCH or the PSSCH in the reception period.

### BRIEF DESCRIPTION OF THE DRAWINGS

FIG. 1 is a diagram illustrating D2D communication in a wireless communication system according to an exemplary embodiment of the present invention.

FIGS. 2 and 3 are diagrams illustrating a D2D transmission scheme in an LTE system according to the exemplary embodiment of the present invention, respectively.

FIG. 4 is a diagram illustrating a method for control information transmission according to another exemplary embodiment of the present invention.

FIG. 5 is a diagram illustrating a structure of a PSCCH according to an exemplary embodiment of the present invention.

FIGS. 6 and 7 are diagrams illustrating an example of a method for data transmission according to yet another exemplary embodiment of the present invention, respectively.

FIG. 8 is a diagram illustrating an apparatus for opportunistic data transmission in D2D terminals according to still another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise” and variations such as “comprises” or “comprising”, will be understood to imply the inclusion of stated elements but not the exclusion of any other elements.

Hereinafter, a method and an apparatus for opportunistic data transmission according to exemplary embodiments of the present invention will be described in detail with reference to the accompanying drawings.

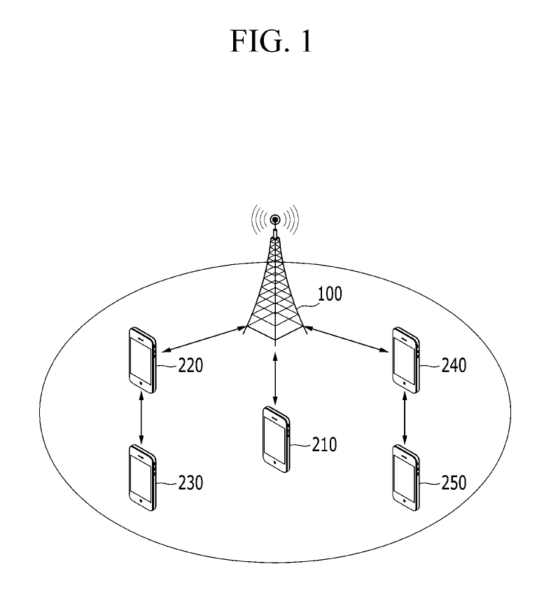

FIG. 1 is a diagram illustrating D2D communication in a wireless communication system according to an exemplary embodiment of the present invention.

Referring to FIG. 1, in an LTE system as a wireless communication system, D2D communication means that two neighboring terminals (for example, 220 and 230 or 240 and 250) under coverage of the same base station 100 transmit and receive data without relaying to the base station 100 through a direct link, that is, D2D link connection.

After D2D link for direct communication between the neighboring terminals (for example, 220 and 230 or 240 and 250) is set, the terminals (for example, 220 and 230 or 240 and 250) transmit and receive the data through the D2D link without passing through the base station 100.

In the D2D communication, the base station 100 plays a leading part on providing a communication service between the base station 100 and the terminal and manages resources of the D2D link, states of the terminals 210 to 250, a transmission state, and the like. The base station 100 continuously transmits and receives a control signal with the terminals 210 to 250 to analyze a state for the D2D communication and control the D2D communication state on the basis of the analyzed state information.

As merits of the D2D, there are provision of authentication and security of users due to LTE dedicated frequency use, reuse of spatial frequency resources based on terminal proximity, reduction in use power of the terminal through direct communication between the terminals, an increase in capacity of a network through distribution of a base station load, an increase in data transmission speed, an increase in a cell region, and the like. Hereinafter, for convenience of description, the terminal performing D2D communication, that is, transmission and reception is called a D2D terminal, and when the transmission and the reception are separated, a D2D terminal for transmission is called a transmission D2D terminal, and a D2D terminal for reception is called a reception D2D terminal.

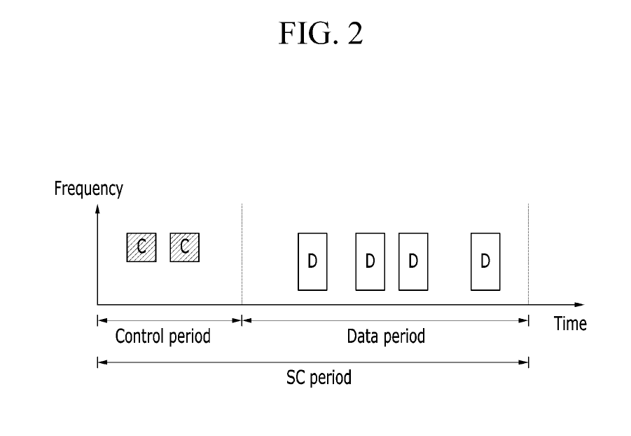

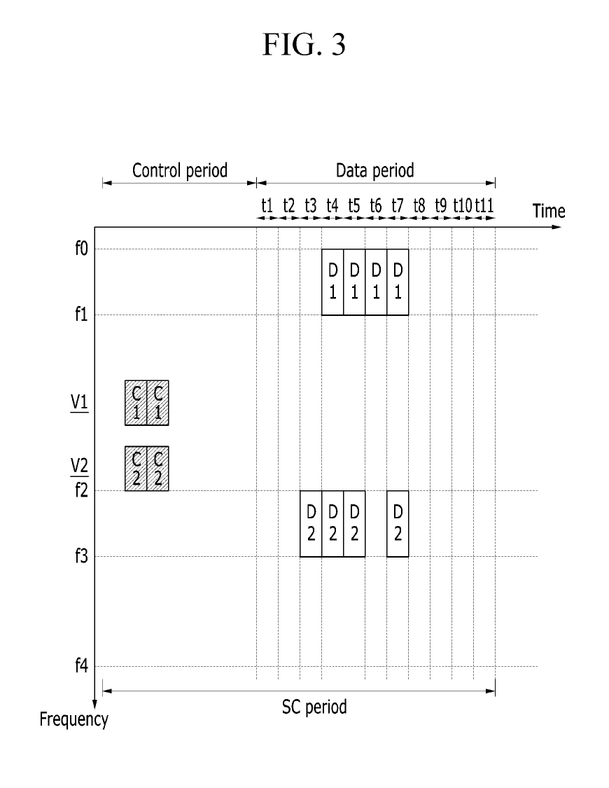

FIGS. 2 and 3 are diagrams illustrating a D2D transmission scheme in an LTE system according to the exemplary embodiment of the present invention, respectively.

Referring to FIG. 2, in the LTE system, a sidelink control (SC) period is repeated in a period for the D2D communication. The SC period is divided into a control period and a data period. Each of the control period and the data period may be divided into a plurality of subperiods in a time domain and a plurality of frequency bandwidths in a frequency domain. The length of one subperiod may be same as the length of a subframe and may also be differently set.

In the control period, a channel transmitting control information C for D2D communication is allocated and in the data period, a channel transmitting D2D data D is allocated. In the D2D communication, as the channel transmitting the D2D data D, a physical sidelink shared channel (PSSCH) is used, and as the channel transmitting the control information C for D2D communication, a physical sidelink control channel (PSCCH) is used.

The base station 100 sets a resource pool required for the D2D communication. The resource pool required for the D2D communication may be divided into a control information pool and a D2D data pool. The base station 100 schedules the control information and the data transmission resource in the resource pool set to the transmission D2D terminal, respectively. The transmission D2D terminal allocates the PSSCH and the PSCCH by using the scheduled control information and a data transmission resource, respectively, and may transmit the control information and the D2D data through the PSSCH and the PSCCH.

In the LTE system, in the D2D communication, the transmission D2D terminal repetitively allocates the PSCCH two times in the control period and repetitively allocates the PSSCH four times in the data period. The PSSCH may be continuously allocated and discontinuously allocated, and also distributively allocated in the frequency domain. Further, the PSSCH may be disposed to be maximally distributed in the time domain and the frequency domain.

The transmission D2D terminal transmits sidelink control information (SCI) format 0 through the PSCCH, and the SCI format 0 includes position information of the PSSCH, a reception group identifier, a modulation and coding scheme (MCS), information for synchronization (timing advance indication), frequency hopping-related information, and the like.

According to the exemplary embodiment of the present invention, the SCI format 0 further includes priority of the D2D data and/or event-driven information. The D2D data corresponding to specific priority information or the event-driven information means data to be received by all the D2D terminals or a specific D2D terminal, and the priority and/or the event-driven information may include information representing the priority and/or the event-driven, a reception identifier to receive the corresponding D2D data, and the like.

The transmission D2D terminal repetitively transmits the SCI format 0 two times through the PSCCH repeated two times in the control period and repetitively transmits the D2D data four times through the PSSCH repeated four times in the data period.

The reception D2D terminal detects the SCI format 0 of the PSCCH, determines the resource position of the PSSCH by using the SCI format 0, and may recover the D2D data in the PSSCH.

The transmission scheme of the D2D communication is applied to a plurality of terminals as illustrated in FIG. 3.

Referring to FIG. 3, D2D terminals V1 and V2 may repetitively allocate the PSCCH two times in the control information pool and transmit the SCI format 0 C1 and C2 through the PSCCH which is repetitively allocated two times. The PSCCHs of the D2D terminals V1 and V2 are allocated in the same frequency bandwidth (between a frequency f1 and a frequency f2) and the same time domain.

Further, the D2D terminals V1 and V2 may repetitively allocate the PSSCH four times in the D2D data pool and repetitively transmit the D2D data D1 and D2 four times through the PSSCH repeated four times. The PSSCH of the D2D terminal V1 is continuously allocated in four subperiods t4 to t7 in the frequency bandwidth between the frequency f0 and the frequency f1, and the PSSCH of the D2D terminal V2 is allocated to four subperiods t3 to t5 and t7 in the frequency bandwidth between the frequency f2 and a frequency f3.

As such, the PSSCH resource positions of the D2D terminals V1 and V2 may be equally allocated, and in this case, a situation in which the D2D terminal V2 needs to receive the D2D data of the D2D terminal V1 may occur. For example, when the D2D data of the D2D terminal V1 is data which needs to be received all of the D2D terminals or be received by the D2D terminal V2, the D2D terminal V2 needs to receive the D2D data of the D2D terminal V1. The D2D terminals V1 and V2 use a half-duplex transmission scheme to perform only the transmission or reception in one timing. Accordingly, the D2D terminal V2 may not receive the SCI format 0 transmitted by the D2D terminal V1. As a result, the D2D terminal V2 may not determine the position of the D2D data D1 and the information required for recovering the data, and resultantly, may not recover the D2D data D1.

Meanwhile, at the resource position of the PSSCH allocated to the D2D terminals V1 and V2, a D2D terminal V3 which does not transmit the SCI format 0 may receive all of the PSSCHs transmitted by the D2D terminals V1 and V2. Accordingly, at the resource position of the PSSCH allocated to the D2D terminals V1 and V2, both the D2D data D1 and D2 may be recovered.

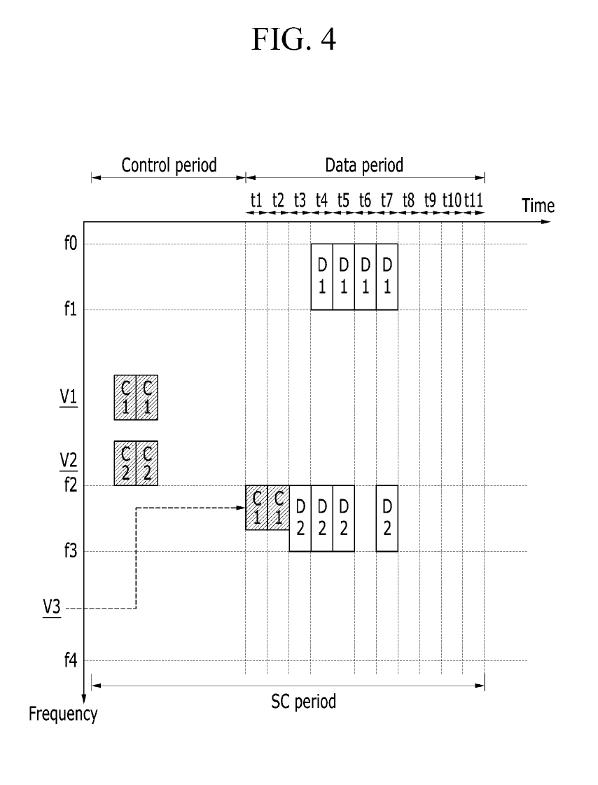

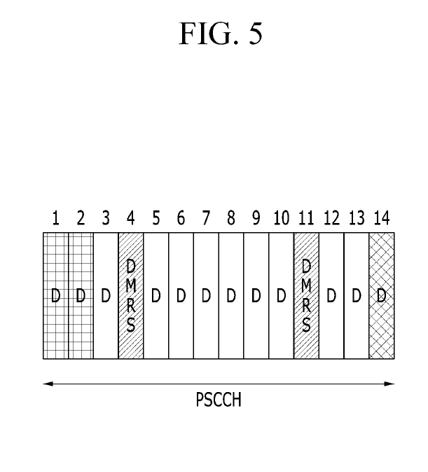

As such, when the D2D terminals V1 and V2 transmit the SCI format 0 C1 and C2 at the same PSCCH resource position, a method for recovering the D2D data D2 or D1 of the counter D2D terminals V2 and V1 in a situation where at least one of the D2D terminals V1 and V2 needs to receive the D2D data D2 or D1 of the counter D2D terminals V2 or V1 will be described in detail with reference to FIGS. 4 and 5.

FIG. 4 is a diagram illustrating a method for control information transmission according to another exemplary embodiment of the present invention.

Referring to FIG. 4, even though the resource positions of the PSCCH of the D2D terminals V1 and V2 are equal to each other, the D2D terminal V3 does not transmit the SCI format 0 at the resource position of the PSCCH allocated to the D2D terminals V1 and V2, and as a result, the D2D terminal V3 may receive the PSCCHs of the D2D terminals V1 and V2.

When the D2D terminal V3 simultaneously receives the PSCCHs of the D2D terminals V1 and V2, the D2D terminal V3 determines whether the counter D2D terminals V2 and V1 need to receive the D2D data D1 and D2 of the D2D terminal V1 and V2. The D2D terminal V3 may determine whether the counter D2D terminals V1 and V2 need to receive the D2D data D1 and D2 of the D2D terminals V1 and V2 through the priority and/or the event-driven information set in the SCI format 0 C1 and C2 of the D2D terminals V1 and V2.

When the D2D terminal V2 needs to receive the D2D data D1 of the D2D terminal V1, the D2D terminal V3 repetitively allocates the PSCCH two times in a partial period of the data period and repetitively transmits the SCI format 0 C1 of the D2D terminal V1 twice through the PSCCH repetitively allocated two times.

In detail, each of the D2D terminals V1 to V3 sets a predetermined reception period before or after transmitting the D2D data in the data period. It is assumed that the data period is divided into a plurality of subperiods t1 to t11 and the length of one subperiod corresponds to a time length transmitting one PSSCH. For example, when the PSSCH of the D2D terminal V1 is allocated in the subperiods t4 to t8, the D2D terminal V1 may set two subperiods t2 and t3 just before the subperiod t4 or two subperiods t8 and t9 just after the subperiod t3 as a reception period. Further, when the PSSCH of the D2D terminal V2 is allocated in the subperiods t3 to t5 and t7, the D2D terminal V2 may set subperiods t1 and t2 just before the subperiod t3 or two subperiods t8 and t9 just after the subperiod t7 as a reception period.

The D2D terminal V3 may determine the resource position of the PSSCH of the D2D terminal V2 through the SCI format 0 C1 and C2 transmitted by the D2D terminal V2 and determine the reception period of the D2D terminal V2 based on the resource position of the PSSCH of the D2D terminal V2. The D2D terminal V3 repetitively allocates the PSCCH two times in the reception period (for example, t1 and t2) of the D2D terminal V2 and repetitively transmits the SCI format 0 C1 of the D2D terminal V1 two times through the PSCCH repetitively allocated two times.

Then, the D2D terminal V2 may receive the SCI format 0 C1 of the D2D terminal V1 in the reception period and recover the D2D data D1 of the D2D terminal V1 by determining the resource position of the PSSCH of the D2D terminal V1 through the SCI format 0 C1 of the D2D terminal V1.

FIG. 5 is a diagram illustrating a structure of a PSCCH according to an exemplary embodiment of the present invention.

Referring to FIG. 5, one PSCCH may include a plurality of orthogonal frequency division multiplex (OFDM) symbols in the time domain and a plurality of resource blocks in the frequency domain. The resource block includes a plurality of subcarriers in the frequency domain. The OFDM symbol may be called an OFDMA symbol, an SC-FDMA symbol, or the like according to a multiple access scheme. The number of OFDM symbols included in one slot may be variously changed according to a channel bandwidth or the length of a CP. A time taken to transmit one PSCCH is defined as a transmission time interval (TTI), and in the LTE system, the TTI is set to be the same as the length of the subframe. In the case of a normal CP, one subframe includes 14 transmission symbols, but in the case of an extended CP, one slot may include 12 transmission symbols.

As described above, the SCI format 0 according to the exemplary embodiment of the present invention is transmitted through the PSCCH, and the SCI format 0 includes the priority and/or event-driven information. The priority and/or event-driven information may be constituted by Nₚ bits. For example, in the case where Nₚ=2, 00 has the highest priority and the priority may be determined in order of 01, 10, and 11. The priority and/or event-driven information may be mapped in the resource block of two first OFDM symbols of the PSCCH.

The D2D terminal V3 receiving the SCI format 0 C1 and C2 may find the priority of the corresponding D2D data D1 or D2 to be received through bit information mapped at two first OFDM symbols of the PSCCH.

Further, in the reception period of the data period, since the PSCCH may be transmitted, the D2D terminal V2 needs to distinguish whether the channel received in the reception period is the PSCCH or the PSSCH. To this end, the D2D terminals V1 and V2 transmit demodulation reference signals (DMRS) capable of distinguishing the PSCCH through the PSCCH. For example, the DMRS may be mapped in the resource block of the fourth symbol of the PSCCH. In addition, other information D of the SCI format 0 may be mapped in resource blocks of the remaining OFDM symbol positions of the PSCCH.

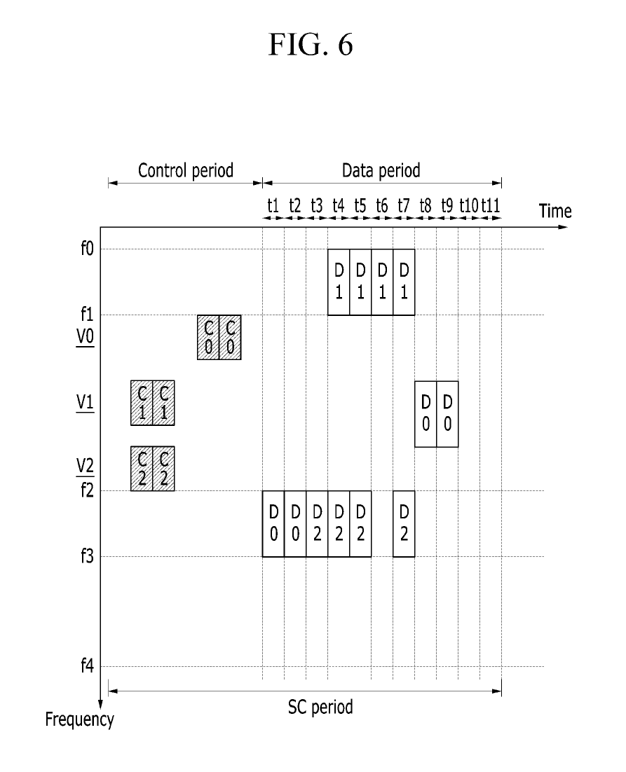

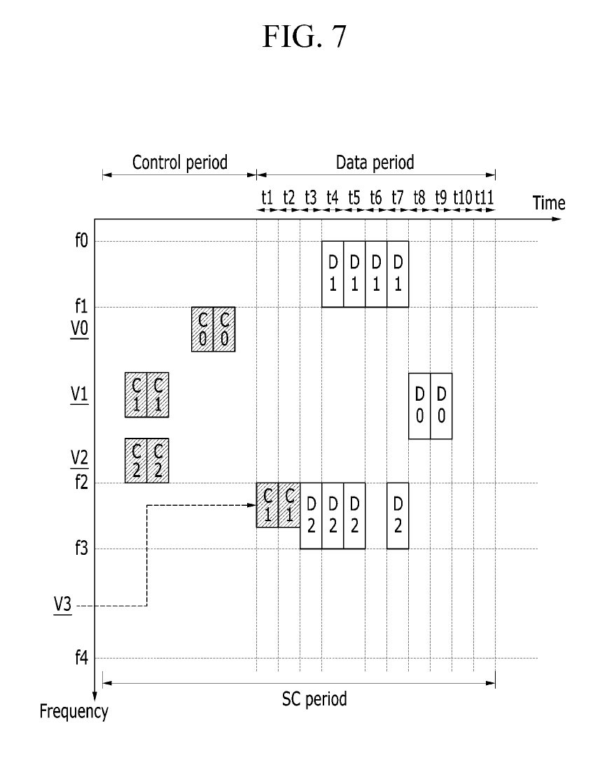

FIGS. 6 and 7 are diagrams illustrating an example of a method for data transmission according to yet another exemplary embodiment of the present invention, respectively.

As illustrated in FIG. 6, a PSSCH of a D2D terminal V0 is allocated in the subperiods t1 and t2 in the frequency bandwidth between the frequency f2 and the frequency f3 and the subperiods t8 and t9 in the frequency bandwidth between the frequency f1 and the frequency f2. In this case, as illustrated in FIG. 4, when the D2D terminal V3 repetitively allocates the PSCCH two times in the reception periods t1 and t2 of the D2D terminal V2, collision between D2D data D0 transmitted by the D2D terminal V0 and the SCI format 0 C1 of the D2D terminal V1 transmitted by the D2D terminal V3 may occur.

In order to prevent the collision, as illustrated in FIG. 7, the D2D terminal V0 does not transmit the D2D data D0 in the subperiods t1 and t2. In detail, the D2D terminal V0 determines whether the counter D2D terminal V2 needs to receive the D2D data D1 of the D2D terminal V1 through the priority and/or the event-driven information set in the SCI format 0 C1 and C2 of the D2D terminals V1 and V2. Further, the D2D terminal V0 may determine the reception period of the D2D terminal V2 based on the resource position of the PSSCH of the D2D terminal V2. In addition, the D2D terminal V0 does not transmit the D2D data DO at the corresponding position when the resource position of the PSSCH of the D2D terminal V0 and the reception period of the D2D terminal V2 overlap with each other.

Meanwhile, the D2D terminals receiving the SCI format 0 C0 through the PSCCH of the D2D terminal V0 do not find that the D2D data D0 is not transmitted and the SCI format 0 C1 is transmitted for the subperiods t1 and t2 in the frequency bandwidth between the frequency f2 and the frequency f3. Since the SCI format 0 C1 and the DMRS of the D2D data D0 are different from each other, the D2D terminals receiving the SCI format 0 C0 and the terminal (for example, V2) in which the subperiods t1 and t2 are set as the reception period estimates whether the channel transmitted in the subperiods t1 and t2 is the PSCCH or the PSSCH by using a correlation of the DMRS. When the channel transmitted in the subperiods t1 and t2 is the PSCCH, the D2D terminals corresponding to the corresponding reception group identifier receive the D2D data D1 at the corresponding position.

In addition, in FIGS. 4 and 7, it is described that the D2D terminal V3 transmits the SCI format 0 C1 through the PSCCH of the D2D terminal V1, but when a plurality of D2D terminals receiving the SCI format 0 C1 and C2 through the PSSCH transmitted from the D2D terminals V1 and V2 is present, a terminal to transmit the SCI format 0 C1 among the plurality of D2D terminals needs to be determined. Since the D2D terminals finds the adjacent terminals at one hop position, the closest D2D terminal to the D2D terminal V2 needs to receive the SCI format 0 C1 may be determined as a terminal to transmit the SCI format 0 C1 among the plurality of D2D terminals which does not transmit the SCI format 0 at the resource position of the PSSCH allocated to the D2D terminals V1 and V2. As such, in addition to the geographical position, a terminal to transmit the SCI format 0 C1 may be determined by using signal intensity and the like, and the D2D terminal (for example, V0) receiving the resource in the reception period of the D2D terminal V2 may be determined as the terminal to transmit the SCI format 0 C1. A reference for determining the terminal to transmit the SCI format 0 C1 may be preconfigured through system information.

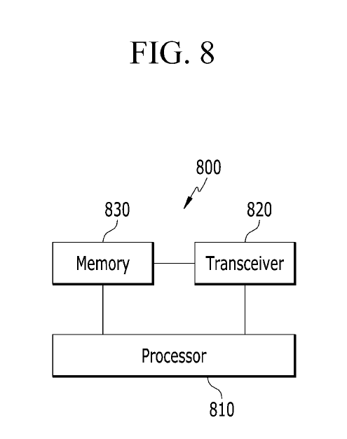

FIG. 8 is a diagram illustrating an apparatus for opportunistic data transmission in D2D terminals according to still another exemplary embodiment of the present invention.

Referring to FIG. 8, an apparatus 800 for opportunistic data transmission of the D2D terminal includes a processor 801, a transceiver 820, and a memory 830.

The processor 810 allocates the PSCCH and the PSSCH by using the control information and the data transmission resource received from the base station 100, respectively, and maps the control information and the D2D data in the resource positions of the PSCCH and the PSSCH. The control information includes the priority and/or event-driven information of the D2D data as described above. The processor 810 repetitively allocates the PSCCH two times in the control period and repetitively allocates the PSSCH four times in the data period for D2D communication. Further, the processor 810 sets a predetermined period temporally just before or after the resource position of the PSSCH in which the D2D data is mapped in the data period as the reception period and may detect the PSCCH or the PSSCH received in the predetermined reception period. The processor 810 may estimate whether the channel received by using the DMRS of the PSCCH or the PSSCH is the PSCCH or the PSSCH. Further, the processor 810 determines whether to transmit the SCI format 0 of the PSCCH received through the SCI format 0 of the PSCCH which is simultaneously received from different D2D terminals, allocates the PSCCH in response to the reception period of the D2D terminal to receive the SCI format 0 of the received PSCCH, and may set the received D2D terminal and map the SCI format 0 of the received PSCCH in the resource position of the PSCCH.

The transceiver 820 transmits and receives the control information and the D2D data to and from the other D2D terminal through the allocated DELETEDTEXTSSCCH and PSSCH. Further, the transceiver 820 may also transmit and receive the control information and the data to and from the base station 100.

The memory 830 stores instructions to be executed in the processor 810 or loads and temporarily stores the instructions from a storage device (not illustrated), and the processor 810 may execute the instructions stored or loaded in the memory 830.

The processor 810 and the memory 830 may be connected to each other through a bus (not illustrated), and an input/output interface (not illustrated) may also be connected to the bus. In this case, the transceiver 820 is connected to the input/output interface, and peripheral devices such as an input device, a display, a speaker, and a storage device may be connected to the input/output interface.

The method and the apparatus for opportunistic data transmission according to the exemplary embodiment of the present invention described above are described based on the D2D communication, but may also be applied to vehicle-to-vehicle (V2V) communication.

According to the exemplary embodiment of the present invention, in the D2D, even when the terminals using the half-duplex transmission scheme simultaneously transmit the control information, the data of the other terminal may be restored and as a result, more efficient D2D communication is possible.

The exemplary embodiment of the present invention is not implemented only by the apparatus and/or method described above, but may also be implemented by a program for realizing a function corresponding to the configuration of the exemplary embodiment of the present invention, and recording media on which the program is recorded, and the implementation may be easily made from the disclosure of the exemplary embodiment described above by experts in the technical field to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for opportunistic data transmission which opportunistically transmits data in a device-to-device (D2D) terminal, comprising:
receiving control information simultaneously from two or more different D2D terminals; and
transmitting control information of a first D2D terminal of at least one of the two or more D2D terminals to a second D2D terminal of at least the other one of the two or more D2D terminals.

2. The method for opportunistic data transmission of claim 1, wherein:
the transmitting includes determining whether the second terminal needs to receive the control information of the first terminal.

3. The method for opportunistic data transmission of claim 2, wherein:
the control information includes information on a resource position of the D2D data to be transmitted by the corresponding D2D terminal and priority of the D2D data.

4. The method for opportunistic data transmission of claim 3, wherein:
the control information further includes event-driven information of the D2D data.

5. The method for opportunistic data transmission of claim 3, wherein:
the control information is mapped in a transmission resource of a physical sidelink control channel (PSCCH) and a demodulation reference signal capable of distinguishing the PSCCH is mapped in another transmission resource of the PSCCH.

6. The method for opportunistic data transmission of claim 3, wherein:
the determining includes determining whether the second terminal needs to receive the control information of the first terminal based on the information on the priority of the D2D data to be transmitted by the first terminal.

7. The method for opportunistic data transmission of claim 3, wherein:
the transmitting includes
determining a resource position of the D2D data to be transmitted by the second terminal base on the control information of the second terminal, and
transmitting the control information of the first D2D terminal for a partial period except for the resource position of the D2D data to be transmitted by the second terminal in the set data period.

8. The method for opportunistic data transmission of claim 7, wherein:
the resource position includes a time position.

9. The method for opportunistic data transmission of claim 8, wherein:
the partial period includes a period temporally just before or just after at the resource position of the D2D data to be transmitted by the second terminal.

10. The method for opportunistic data transmission of claim 3, further comprising:
receiving the D2D data from the two or more different D2D terminals.

11. The method for opportunistic data transmission of claim 10, wherein:
the receiving of the control information includes transmitting the control information repetitively two times by the two or more different D2D terminals in the control period, and
the receiving of the D2D data includes transmitting the D2D data repetitively four times by the two or more different D2D terminals in the data period.

12. An apparatus for opportunistic data transmission of a device-to-device (D2D) terminal, the apparatus comprising:
a transceiver receiving control information simultaneously from two or more different D2D terminals in a control period; and
a processor determining whether to transmit control information of a first D2D terminal of at least one of the two or more D2D terminals to a second D2D terminal of at least the other one of the two or more D2D terminals, setting the second D2D terminal as a reception identifier, and mapping the control information of the first D2D terminal in a transmission resource in the data period.

13. The apparatus for opportunistic data transmission of claim 12, wherein:
the control information includes at least one of information on priority of the D2D data to be transmitted by the corresponding D2D terminal and information on event-driven of the D2D data and a transmission resource position of the D2D terminal.

14. The apparatus for opportunistic data transmission of claim 13, wherein:
the processor determines whether to transmit the control information of the first D2D terminal to the second D2D terminal based on at least one of the information on the priority of the D2D data and the information on the event-driven of the D2D data.

15. The apparatus for opportunistic data transmission of claim 13, wherein:
the processor determines a resource position of the D2D data to be transmitted by the second terminal based on the control information of the second terminal, and maps the control information of the first D2D terminal in a transmission resource of a partial period except for the transmission resource position of the D2D data to be transmitted by the second terminal in the data period.

16. The apparatus for opportunistic data transmission of claim 15, wherein:
the partial period includes a period temporally just before or just after at the resource position of the D2D data to be transmitted by the second terminal.

17. The apparatus for opportunistic data transmission of claim 12, wherein:
the control information is included in a sidelink control information (SCI) format 0, and
the processor detects a physical sidelink control channel (PSCCH) in the control period to determine control information in the SCI format 0.

18. The apparatus for opportunistic data transmission of claim 12, wherein:
the processor includes the information on the priority of the D2D data to be transmitted and the information on the event-driven of the D2D data in SCI format 0 when the D2D data to be transmitted is generated, repetitively allocates the PSCCH two times in the control period, and maps the SCI format 0 in the transmission resource position of the PSCCH repetitively allocated two times.

19. The apparatus for opportunistic data transmission of claim 18, wherein:
the processor repetitively allocates a physical sidelink shared channel (PSSCH) four time in the data period and maps the D2D data to be transmitted in the transmission resource position of the PSSCH repetitively allocated four times.

20. The apparatus for opportunistic data transmission of claim 19, wherein:
the processor sets a predetermined time period temporally just before or just after based on the transmission resource position of the allocated PSSCH as a reception period and detects the PSCCH or the PSSCH in the reception period.
